(19) United States
(12) Patent Application Publication
(10) Pub. No.: US 2006/0256345 A1
(43) Pub. Date: Nov. 16, 2006

(54) Interferometry measurement in disturbed environments

(75) Inventor: Romain Sappey, San Diego, CA (US)

Correspondence Address: CAVEN & AGHEVLI LLC, 9249 S. BROADWAY BLVD., UNIT 200-201, HIGHLANDS RANCH, CO, 80129, US

(73) Assignee: KLA-Tencor Technologies Corp.

(21) Appl. No.: 11/127,428

(22) Filed: May 12, 2005

(51) Int. Cl. G01B 11/02

(52) U.S. Cl. 356/498

(57) ABSTRACT

In embodiments, techniques for interferometry measurements in disturbed environments are described. The disturbed environment may include one or more variations such as pressure variations and/or thermal variations. In one embodiment, a difference between an optical path of a first beam and an optical path of a second beam is detected. One or more of the first or second beams may be encased in a shroud proximate to the disturbed environment. The method may further couple a window to the shroud in proximity to the disturbed environment, e.g., to reduce the negative effects of the disturbed environment.

### BACKGROUND

The subject matter described herein generally relates to interferometry measurement. In one embodiment, techniques described herein provide interferometry measurement for testing storage devices.

In some storage devices such as hard disk drives, a head is kept near a rotating disk. The head enables magnetic (rather than physical) access to the disk to read and/or write bits of data. If the head touches the disk surface, the data that is magnetically stored on the disk may be damaged. Also, damage to the head may occur if the head physically contacts the rotating disk. In some current hard disk drives, extensive damage may be caused to both the head and the rotating disk surface if they physically come in contact, since the disks can spin at speeds of several thousands of revolutions per minute (RPM).

To store as much data as possible in a given footprint of a hard disk drive, the heads are kept at increasingly shorter distances from the rotating disks. Hence, accurate measurement of the distance between the head and the rotating disk is needed to control the slider manufacturing process, and ensure that the recording heads fly at the proper height.

### SUMMARY

In various embodiments, techniques for interferometry measurements in disturbed environments are described. The disturbed environment may include one or more variations such as pressure variations and/or thermal variations. For example, the disturbed environment may be generated by a rotating disk in an optical flying height tester.

In one embodiment, a method includes detecting a difference between an optical path of a first beam and an optical path of a second beam. One or more of the first or second beams may be encased in a shroud proximate to a disturbed environment e.g., to reduce the negative effects of the disturbed environment. The method may further couple a window to the shroud in proximity to the disturbed environment, e.g., to further reduce the negative effects of the disturbed environment.

In a further embodiment, an apparatus includes a detector to determine a difference in an optical path of a first beam and an optical path of a second beam. One or more of the first or second beams may be reflected off of a first object and a second object, respectively. Alternatively, one of the beams may be an internal reference beam. The apparatus may further include a shroud to encase the first beam and a second beam proximate to the disturbed environment.

Additional advantages, objects and features of embodiments of the invention are set forth in part in the detailed description which follows. It is to be understood that both the foregoing general description and the following detailed description are merely exemplary of embodiments of the invention, and are intended to provide an overview or framework for understanding the nature and character of embodiments of the invention.

### BRIEF DESCRIPTION OF THE DRAWINGS

The accompanying drawings are included to provide further understanding of embodiments of the invention, illustrate various embodiments of the invention, and together with the description serve to explain the principles and operation of the invention. In the figures, the left-most digit(s) of a reference number identifies the figure in which the reference number first appears. The use of the same reference numbers in different figures indicates similar or identical items.

FIG. 1 is a schematic diagram of portions of an optical flying height testing system, according to an embodiment.

FIG. 2 illustrates an embodiment of a system for generating and/or detecting one or more beams, such as the beams discussed with reference to FIG. 1.

FIG. 3 is a flow diagram of an embodiment of a method for measuring a gap between objects in a disturbed environment.

### DETAILED DESCRIPTION

In the following description, numerous specific details are set forth in order to provide a thorough understanding of embodiments of the present invention. Embodiments of the present invention may be practiced without some or all of these specific details. In other instances, well known process operations have not been described in detail in order not to unnecessarily obscure the present invention.

Also, reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

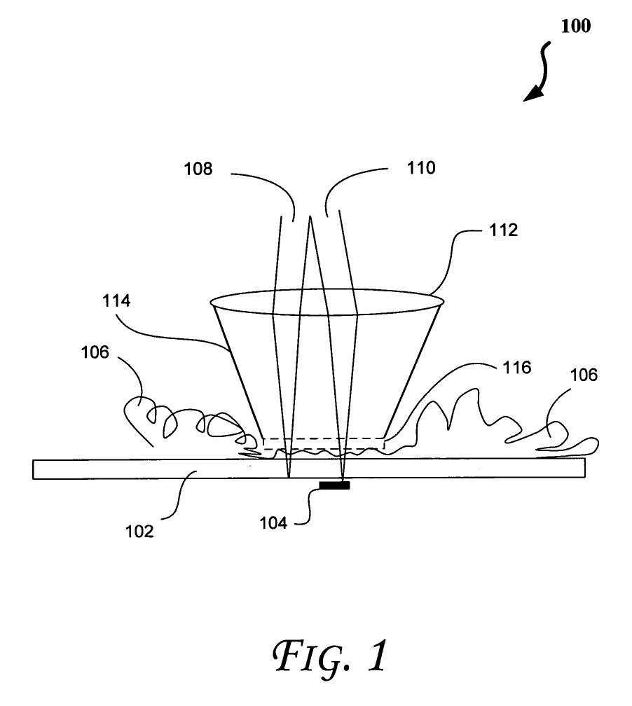

FIG. 1 is a schematic diagram of portions of an optical flying height testing system 100, according to an embodiment. The system 100 includes a rotating disk 102 that may be transparent to electromagnetic radiation, such as a glass test disk. A slider 104 is proximate to the disk 102, e.g., within nanometers or fractions thereof. The slider may be AlTiC (Alumina Titanium Carbide) in one embodiment. The disk 102 may be rotated at relatively high RPM to simulate the rotation of an actual rotating disk in a hard disk drive. The rotation of the disk 102 may disturb the environment (106) proximate to the disk 102. The disturbed environment 106 may be turbulent, or more generally an environment with pressure and/or temperature variations.

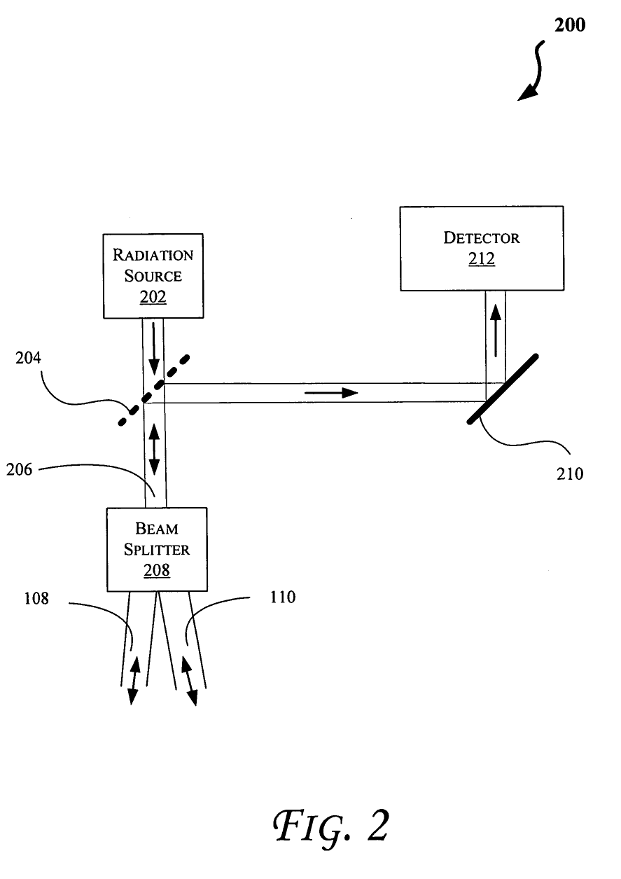

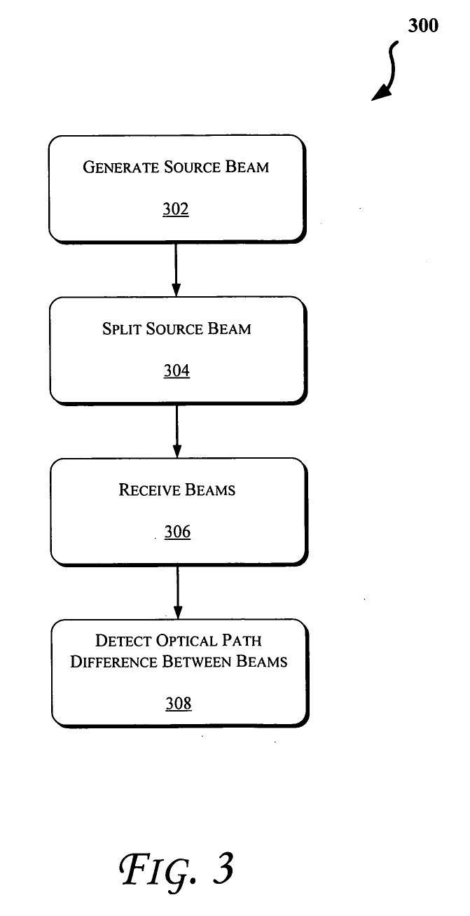

As illustrated in FIG. 1, one or more beams (108 and 110) may pass through the disk 102 and bounce off of the bottom of the disk 102 (108) and the slider 104 (110). The beams 108 and 110 may be collimated. As will be further discussed herein, e.g., with reference to FIGS. 2 and 3, the optical path difference between the beams 108 and 110 may be utilized to measure the gap between the disk 102 and the slider 104. The path difference between beams 108 and 110 may be affected by the temperature and/or pressure variations of the air above the rotating disk 102, because each may create undesired changes in the index of refraction of the air. The effect may be greater as the physical separation between the two beams 108 and 110 increases, as they go through different and, e.g., less correlated temperature and/or pressure inhomogeneities.

The system 100 may further include an objective lens 112 to focus the beams 108 and 110 on the bottom surface of the disk 102 and/or the slider 104. Since the disk 102 and slider 104 may have a gap that ranges in nanometers or fractions thereof, the lens 112 may be utilized to focus the beams 108 and 110 on the same focal plane in one embodiment. The objective lens 112 may have any suitable shape such as concave (or convex) or semi-concave (or semi convex), and may be adjusted by moving the lens 112 in a plane that is substantially perpendicular to the rotational plane of the disk 102. The lens 112 may be constructed with any suitable material such as glass, quartz, fused Silica, or combinations thereof. Also, multiple lenses may be utilized in various embodiments, such as one for each beam (108 and/or 110).

The system may further include a shroud 114 to reduce the negative effects of the environmental disturbance 106 that may be present proximate to the disk 102 (e.g., due to the rotation of the disk 102). The shroud 114 may reduce the inhomogeneities discussed above, e.g., to improve the measurement repeatability. The shroud 114 may improve the measurement repeatability in two ways. First, it may reduce the distance traveled in the disturbed environment 106, therefore reducing the contribution of temperature and/or pressure inhomogeneities to the optical phase difference between the beams 108 and 110. Second, the shroud 114 may improve the uniformity of the optical path traversed by the beams 108 and 110. For example, the presence of the shroud 114 may provide a gas flow between a detector (e.g., detector 212 of FIG. 2) and the rotating disk 102 that approaches a laminar flow, substantially reducing the negative effects of the disturbed environment 106. Also, the volume of gas present in the shroud 114 may be pressure and/or temperature controlled to provide a substantially isothermal environment. The shroud 114 may be attached to the lens 112 in one embodiment, e.g., to provide a sealed environment and/or for ease of assembly or mounting.

Additionally, the shroud 114 may be coupled to an optional window 116. The window 116 may be coupled to the shroud 114 in proximity of the disturbed environment 106 to further reduce the negative effects of the environmental disturbance 106, e.g., by limiting or preventing the flow of air (or other gases) generated by the rotation of the disk 102 to enter the shroud 114 and perturb the volume of air (or other gases) inside the shroud 114. The presence of the window 116 on shroud 114 may help provide a gas flow between a detector (e.g., detector 212 of FIG. 2) and the rotating disk 102 that approaches a laminar flow, further reducing the negative effects of the disturbed environment 106. In one embodiment, the window 116 may be located proximate to the disk 102 and as close as a safe operation of the system 100 allows. For example, the close proximity of the window 116 and the disk 102 may increase the proportion of steady gas flow (e.g., internal air) that the beams 108 and 110 propagate through and/or increase the confinement of the flow to reduce the measurement noise created by the disturbance (116) crossed by the beams 108 and 110, e.g., by further homogenizing the temperature and/or pressure of the gases (e.g., airflow) in the disturbance area (116).

The window 116 may be transparent (to electromagnetic radiation) and may have anti-reflective coating. The window 116 may be constructed with any suitable material such as glass, fused Silica, quartz, or combinations thereof. Additionally, the window 116 may be tilted relative to the disk 102 (not shown), e.g., to reduce reflections of the beams 108 and 110. Also, the window 116 may be a lens in one embodiment.

FIG. 2 illustrates an embodiment of a system 200 for generating and/or detecting one or more beams, such as the beams 108 and 110 discussed with reference to FIG. 1. In one embodiment, the system 100 of FIG. 1 and system 200 of FIG. 2 may be combined to provided an interferometer that may utilize the interference of waves (such as of electromagnetic rays) for precise determination of distances. In one embodiment, the systems 100 and 200 may be utilized to measure the gap between the disk 102 and slider 104 prior to testing the flying height of a recording head slider.

A radiation source 202 may provide electromagnetic radiation such as a laser beam. Hence the source 202 may be a laser diode. Also, more than one radiation source may be utilized in an embodiment. The radiation provided by the source 202 may pass through a collimating lens inside the source 202 to direct a collimated beam 206 to a beam splitter 208. The collimated beam may pass through a plate beam splitter 204 that may be used to redirect the reflected beams onto a detector 212. The beam splitter 208 may split the beam 206 to provide the beams 108 and 110 discussed with reference to FIG. 1. The beam splitter 208 may include a suitable polarizer, such as a Wollaston prism, to split the beam 206. In one embodiment, the arrows in FIG. 2 illustrate the direction of the beams between modules discussed with reference to FIG. 2.

After the disk 102 and slider 104 of FIG. 1 reflect the beams 108 and 110, the reflection of these beams may be recombined through the beam splitter 208 and be reflected by the beam splitter 204, and, optionally, a mirror 210, as illustrated in FIG. 2. A detector 212 may receive the reflections and detect the spatial difference between the optical paths of the beams 108 and 110. As illustrated in FIG. 2, the beams 108 and 110 may retrace themselves as they pass through the beam splitter 208. In one embodiment, the non-focused rays (e.g., rays that are not focused by the lens 112 of FIG. 1) may converge and not reach the detector 212. Accordingly, the optical path difference between the beams 108 and 110 may be utilized to determine the gap between the slider 104 and the bottom of the disk 102 of FIG. 1.

FIG. 3 is a flow diagram of an embodiment of a method 300 for measuring a gap between objects in a disturbed environment. For example, the method 300 may be utilized to measure the gap between the disk 102 and slider 104 in the disturbed environment 106 of FIG. 1. A source beam (e.g., the beam 206 of FIG. 2) is generated (302), e.g., by the source 202 of FIG. 2. The source beam (206) may be split (304) by a beam splitter such as the beam splitter 208 of FIG. 2. One or more beams (such as beams 108 and 110 reflected off the bottom of the disk 102 and slider 104 of FIG. 1) may be received (306), e.g., by a detector (e.g., the detector 212 of FIG. 2). The difference between the optical path of the beams (e.g., beams 108 and 110 of FIG. 1) may be detected (308), e.g., to determine the gap between the bottom of the disk 102 and slider 104 of FIG. 1.

Even though the systems 100 and 200 of FIGS. 1 and 2 discuss utilization of an external reference beam (e.g., the beam 108 that reflects off the bottom of the disk 102), since the location of the disk 102 may be known sufficiently accurately, an internal reference beam may be used to determine the location of the slider 104 of FIG. 1, e.g., a reference beam provided internally or externally to the detector 212 of FIG. 2.

In the description and claims, the terms “coupled” and “connected,” along with their derivatives, may be used. In some embodiments of the invention, “connected” may be used to indicate that two or more elements are in direct physical contact with each other. “Coupled” may mean that two or more elements are in direct physical contact. However, “coupled” may also mean that two or more elements may not be in direct contact with each other, but may still cooperate or interact with each other.

Although embodiments have been described in language specific to structural features and/or methodological acts, it is to be understood that claimed subject matter may not be limited to the specific features or acts described. Rather, the specific features and acts are disclosed as sample forms of implementing various embodiments. While the invention has been described above in conjunction with one or more specific embodiments, it should be understood that the invention is not intended to be limited to one embodiment. The invention is intended to cover alternatives, modifications, and equivalents as may be included within the spirit and scope of the invention, such as those defined by the appended claims.

What is claimed is:

1. An apparatus comprising:
a detector to determine a difference in an optical path of a first beam and an optical path of a second beam; and
a shroud to encase one or more of the first or second beams proximate to a disturbed environment.

2. The apparatus of claim 1, further comprising a beam splitter to split a single beam generated by a radiation source into the first and second beams.

3. The apparatus of claim 1, wherein the disturbed environment comprises one or more pressure variations or thermal variations.

4. The apparatus of claim 1, wherein the disturbed environment is a turbulent environment.

5. The apparatus of claim 1, wherein the shroud reduces an effect of the disturbed environment.

6. The apparatus of claim 1, wherein the disturbed environment is proximate to at least one object that reflects the first beam.

7. The apparatus of claim 1, further comprising a window proximate to the disturbed environment and coupled to the shroud to reduce an effect of the disturbed environment.

8. The apparatus of claim 1, further comprising an objective lens to focus the first and second beams.

9. The apparatus of claim 1, wherein at least one of the first beam or the second beam is an external reference beam.

10. The apparatus of claim 1, wherein at least one of the first beam or the second beam is an internal reference beam.

11. A method comprising:
detecting a difference between an optical path of a first beam and an optical path of a second beam; and
encasing one or more of the first or second beams in a shroud proximate to a disturbed environment.

12. The method of claim 11, wherein detecting the difference provides measurement of a gap between a first object that reflects the first beam and a second object that reflects the second beam.

13. The method of claim 11, wherein the disturbed environment is generated by movement of an object that reflects the first beam.

14. The method of claim 13, further comprising coupling a window to the shroud, wherein the window is located proximate to the object and as close as a safe operation allows.

15. The method of claim 11, wherein detecting the difference measures a flying height of a head over a transparent disk.

16. The method of claim 15, wherein the disturbed environment is generated by the rotating hard disk.

17. The method of claim 11, further comprising coupling a window to the shroud in proximity to the disturbed environment.

18. A system for measuring a gap between a first object and second object, wherein at least one of the first or second objects is proximate to a disturbed environment, the system comprising:
a detector to detect a difference between an optical path of the first beam reflected off of a first object and an optical path of a second beam;
a shroud to encase one or more of the first beam or the second beam proximate to the disturbed environment; and
a window coupled to the shroud in proximity to the disturbed environment to reduce an effect of the disturbed environment.

19. The system of claim 18, wherein the second beam is an internal reference beam.

20. The system of claim 18, wherein the detector detects a difference between the optical path of the first beam and the optical path of the second beam that is reflected off of a second object.
